(19) United States
(12) Patent Application Publication
(10) Pub. No.: US 2025/0110295 A1
(43) Pub. Date: Apr. 3, 2025

(54) POLYETHYLENE OXIDE-BASED OPTICAL ADHESIVE

(71) Applicant: Intel Corporation, Santa Clara, CA (US)

(72) Inventors: Ziyin Lin, Chandler, AZ (US); Saikumar Jayaraman, Chandler, AZ (US); Yiqun Bai, Chandler, AZ (US); Fan Fan, Chandler, AZ (US); Dingying Xu, Chandler, AZ (US)

(73) Assignee: Intel Corporation, Santa Clara, CA (US)

(21) Appl. No.: 18/478,077

(22) Filed: Sep. 29, 2023

(51) Int. Cl. G02B 6/42; C09J 171/02

(52) U.S. Cl. CPC G02B 6/4239; C09J 171/02; G02B 6/423

(57) ABSTRACT

A set of optical fibers are set within grooves a substrate to align the optical fibers with a waveguide associated with photonic processing circuitry. The set of optical fibers are adhered within the grooves using a polyethylene oxide (PEO)-based adhesive. The PEO-based adhesive may have a refractive index matched to the refractive index of one or both of the optical fibers or the waveguide.

### STATEMENT REGARDING FEDERALLY SPONSORED RESEARCH AND DEVELOPMENT

This invention was made with Government support under Agreement No. N00164-19-9-0001, awarded by NSWC Crane Division. The Government has certain rights in the invention.

### FIELD

The present disclosure relates in general to the field of photonics, and more specifically, adhesives for securing optical input/output (I/O) interfaces.

### BACKGROUND

In electronics manufacturing, integrated circuit (IC) packaging is a stage of manufacture where an IC that has been fabricated on a die or chip comprising a semiconducting material is coupled to a supporting case or “package” that can protect the IC from physical damage and support electrical interconnection of ICs, dies, or other electronic components on the package. In some cases, a package may be implemented as a printed circuit board (PCB). In the IC industry, the process of fabricating a package is often referred to as packaging, or assembly.

A photonic integrated circuit (PIC) includes integrated photonic devices or elements. PICs are preferred to optical systems built with discrete optical components and/or optical fiber because of the more compact size, lower cost, heightened functionality, and performance of PICs. Silicon PICs or silicon photonics (SiPh) have one or more planar silicon photonic waveguides having diameters less than 1 m, which convey light within the PIC. These planar silicon waveguides terminate at an optical output coupler (OC) suitable for coupling to an optical fiber array (FA) comprising fibers having diameters on the order of a hundred microns. PICs can be used for several applications, such as communications. Efficiently and cheaply aligning optics to couple light into and out of PICs can be a challenge.

### BRIEF DESCRIPTION OF THE DRAWINGS

FIG. 1 is a simplified drawing of one embodiment of a system with an optical I/O interface for an integrated circuit package.

FIG. 2 is a simplified drawing of an example photonics integrated circuit (PIC) device.

FIG. 3 is a diagram illustrating a cross-sectional view of an example optical I/O interface.

FIG. 4 is a diagram illustrating a top view of an example optical I/O interface.

FIG. 5 illustrates example monomers for use in a PEO-based optical adhesive.

FIGS. 6A-6B are diagrams showing example polymer chains for use in a PEO-based optical adhesive.

FIG. 7 is a simplified flow diagram illustrating an example technique for securing optical fibers to an example optical I/O interface.

FIG. 8 is a top view of a wafer and dies that may be included in a microelectronic assembly, in accordance with any of the embodiments disclosed herein.

FIG. 9 is a cross-sectional side view of an integrated circuit device that may be included in a microelectronic assembly, in accordance with any of the embodiments disclosed herein.

FIGS. 10A-10D are perspective views of example planar, gate-all-around, and stacked gate-all-around transistors.

FIG. 11 is a cross-sectional side view of an integrated circuit device assembly that may include a microelectronic assembly, in accordance with any of the embodiments disclosed herein.

FIG. 12 is a block diagram of an example electrical device that may include a microelectronic assembly, in accordance with any of the embodiments disclosed herein.

### DETAILED DESCRIPTION

In various embodiments disclosed herein, an improved optical adhesive is discussed with refractive index attributes, which assist in minimizing assertion loss at interfaces of optical fibers (e.g., of an optical fiber ribbon) with waveguides provided on a die or package to communicate utilizing photon-based signaling. The improved adhesive may exhibit improved physical characteristics including improved hydrophilic attributes to prevent leakage and contamination of nearby components during application and reduced risk of delamination compared with existing silicone-based adhesives, among other example advantages.

In the following description, specific details are set forth, but embodiments of the technologies described herein may be practiced without these specific details. Well-known circuits, structures, and techniques have not been shown in detail to avoid obscuring an understanding of this description. Phrases such as “an embodiment,” “an implementation,” “an instance,” and the like may include features, structures, or characteristics, but not every embodiment necessarily includes the particular features, structures, or characteristics.

Some implementations may have some, all, or none of the features described for other implementations. “First,” “second,” “third,” and the like describe a common object and indicate different instances of like objects being referred to. Such adjectives do not imply objects so described must be in a given sequence, either temporally or spatially, in ranking, or any other manner. “Connected” may indicate elements are in direct physical or electrical contact, and “coupled” may indicate elements co-operate or interact, but they may or may not be in direct physical or electrical contact. Furthermore, the terms “comprising,” “including,” “having,” and the like, as used with respect to embodiments of the present disclosure, are synonymous. Terms modified by the word “substantially” include arrangements, orientations, spacings, or positions that vary slightly from the meaning of the unmodified term.

Reference is now made to the drawings, which are not necessarily drawn to scale, wherein similar or same numbers may be used to designate the same or similar parts in different figures. The use of similar or same numbers in different figures does not mean all figures including similar or same numbers constitute a single or same embodiment. Like numerals having different letter suffixes may represent different instances of similar components. The drawings illustrate generally, by way of example, but not by way of limitation, various embodiments discussed in the present document.

In the following description, for purposes of explanation, numerous specific details are set forth in order to provide a thorough understanding thereof. It may be evident, however, that the novel embodiments can be practiced without these specific details. In other instances, well-known structures and devices are shown in block diagram form in order to facilitate a description thereof. The intention is to cover all modifications, equivalents, and alternatives within the scope of the claims.

As used herein, the phrase “communicatively coupled” refers to the ability of a component to send a signal to or receive a signal from another component. The signal can be any type of signal, such as an input signal, an output signal, or a power signal. A component can send or receive a signal to another component to which it is communicatively coupled via a wired or wireless communication medium (e.g., conductive traces, conductive contacts, air). Examples of components that are communicatively coupled include integrated circuit dies located in the same package that communicates via an embedded bridge in a package substrate and an integrated circuit package attached to a printed circuit board that send signals to or receives signals from other integrated circuit packages or electronic devices attached to the printed circuit board (e.g., via optical wires).

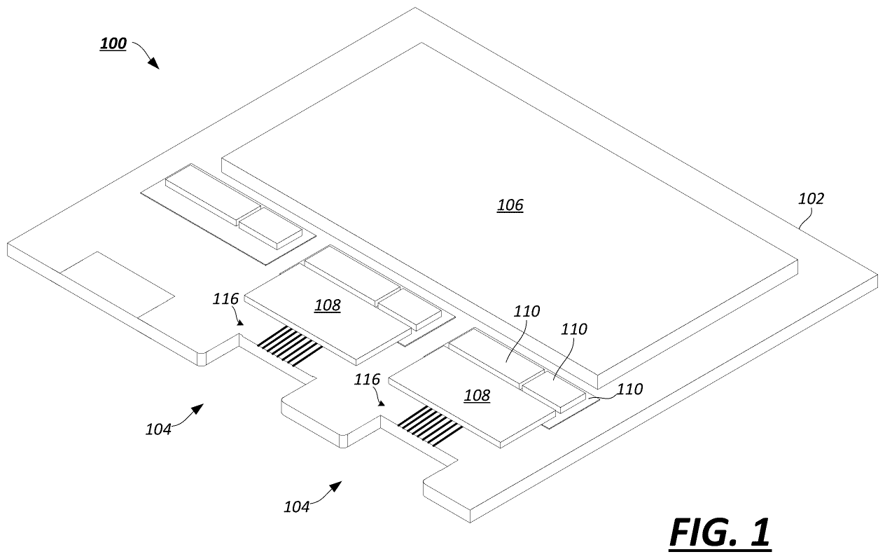

Referring now to FIG. 1, in one example, an integrated circuit package 100 includes a substrate 102, one or more optical interfaces 104, and an electrical integrated circuit (EIC) die 106. In the illustrative embodiment, the optical interfaces 104 are to accept an array of a optical fibers into grooves (e.g., 116) to align the fibers with respective waveguides provided at respective photonic integrated circuit (PIC) dies 108. In some implementations an interposer may be provided for the PIC 108. Waveguides in the interposer and/or PIC can carry light to and/or from optical fibers (inserted in grooves 116) and the PIC dies 108. The substrate 102 may support several additional integrated circuit dies 110, which may be PIC dies, EIC dies, or a combination of both. The additional integrated circuit dies 100 may facilitate communication, power delivery, and other suitable connections between the PIC dies 108 and the EIC die 106, among other example components.

The illustrative substrate 102 may be any suitable substrate, such as glass, silicon, ceramic, a circuit board, etc. In some embodiments, the substrate 102 is a circuit board made from any suitable material, such as ceramic, glass, and/or organic-based materials with fiberglass and resin, such as FR-4. In some embodiments, the substrate 102 is formed from or otherwise includes bismaleimide-triazine (BT) resin. The substrate 102 may have any suitable length or width, such as 10-500 millimeters. The substrate 102 may have any suitable thickness, such as 0.2-5 millimeters. The substrate 102 may support additional components besides those shown in FIG. 1, such as resistors, capacitors, other integrated circuit dies, power electronics, traces, etc.

In some implementations, waveguides used by a PIC to send or receive photon signals may be formed partially or wholly from silicon oxide glass. In other implementations, the waveguide may be made of any suitable material that may be crystalline, non-crystalline, amorphous, etc., such as fused silicon, borosilicate, sapphire, yttrium aluminum garnet, etc. The waveguides may be, e.g., aluminosilicate glass, borosilicate glass, alumino-borosilicate glass, silica, fused silica. The waveguide may include one or more additives, such as Al2O3, B2O3, MgO, CaO, SrO, BaO, SnO2, Na2O, K2O, SrO, P2O3, ZrO2, Li2O, Ti, and Zn. The glass waveguide may include silicon and oxygen, as well as any one or more of aluminum, boron, magnesium, calcium, barium, tin, sodium, potassium, strontium, phosphorus, zirconium, lithium, titanium, and zinc. The material selected for the waveguides and/or optical fibers may be based on the material characteristics of the other (e.g., to match refraction index values of the two materials making up the interface).

The interfaces may serve to route light between an optical cable or ribbon and the PIC dies 108 using waveguides defined at the PICs. The waveguides may be routed in any suitable manner, including in three dimensions, allowing for flexible layouts. The PICs may include optical elements such as fan outs, splitters, couplers, combiners, filters, etc. The PIC die 108 may be made of any suitable material, such as silicon. In the illustrative embodiment, waveguides are defined in the PIC die 108 that interface with optical fiber to transfer light to or from the PIC die 108. For instance, some fibers and waveguides may be dedicated for the transmission of light from the PIC to the fiber cable and other fibers and waveguides may be dedicated for the transmission of light from the fiber cable to the PIC. In one example, waveguides in the PIC die 108 may be silicon waveguides embedded in silicon oxide cladding, among other examples. The PIC dies 108 may include any suitable number of waveguides (e.g., 1-1,024) to accommodate and correspond with varying arrays of fiber optical cables.

The PIC die 108 is configured to generate, detect, and/or manipulate light. The PIC die 108 may include active or passive optical elements such as splitters, couplers, filters, optical amplifiers, lasers, photodetectors, modulators, etc. The PIC die 108 may have electrical connections to the substrate 102 and/or the EIC die 106, such as for power delivery, sending and receiving data, and/or the like. The EIC die 106 may include any suitable electronic integrated circuit package, such as resistors, capacitors, inductors, transistors, etc. The EIC die 106 may include any suitable analog and/or digital circuitry, such as a processor, a memory, an application-specific integrated circuit (ASIC), a field-programmable gate array (FPGA), etc. In some embodiments, the integrated circuit package 100 may be embodied as a router, a switch, a network interface controller, and/or the like. In such embodiments, the EIC die 106 may include network interface controller circuitry to process, parse, route, etc., network packets sent and received by the integrated circuit package 100 through an optical cable attached at the optical interfaces 104.

An interface of an example PIC device, may include a number of grooves configured to accept optical fibers and (at least partially) align the optical fibers with the interface (e.g., waveguides) of the PIC device. For instance, grooves may be formed as one or more lithographically-defined alignment trenches may be recessed in the surface of the PIC chip or at a portion of the package substrate corresponding to an interface with the PIC. The alignment trenches may extend from the edge of the PIC chip to a terminal facet of an optical waveguide, optical fiber, lens or other optical aperture (e.g., on the PIC). Waveguides, in some implementations, may be V-shaped, among other geometries, to encourage secure seating of fibers in the grooves. For instance, the cross section of the alignment trenches may be dimensioned to seat an attached segment of an optical wire during package assembly for accurate alignment with, for example, the optical axis of an integrated waveguide. As an example, the optical wire may be countersunk into the alignment trench. Such passive alignment may obviate more complicated and time-consuming active alignment of the optical wires and may enable rapid package assembly. The alignment trenches may be dimensioned in relation to the diameter of the optical wire or fiber to be used with the PIC, among other example features.

An optical cable may include any suitable number of optical fibers (e.g., 1-32 fibers). The optical fibers may be arranged in a one- or two-dimensional array (e.g., using grooves of varying elevations). Optical fibers may be made out of glass and can carry light at any suitable wavelength (e.g., such as 400-2,000 nanometers). In the illustrative embodiment, the optical fibers may support light in the C-band, O-band, L-band, S-band, etc. In other embodiments, the optical fibers may be made out of a different (e.g., non-glass) material.

Optical interconnects are an emerging, disruptive technology capable of increasing bandwidth and energy efficiency in interconnects adapted for next generation datacenter applications. Co-packaged optics (CPO) and silicon photonics incorporate and are the basis of advanced heterogeneous integration technologies where silicon photonic dies may be packaged with logic dies on a single substrate, such as shown in the example of FIG. 1, eliminating the single loss caused by the copper trace on the motherboard, among other example features and advantages. In a CPO package, optical fibers are used to transmit the light in and out of PICs, which may enable optical interconnect with other devices. However, significant challenges remain in CPO assembly, including fiber alignment accuracy, refractive index matching, optimal thermomechanical properties, and reflow and reliability compatibility, among other example issues. Indeed, there remains no high volume manufacturing (HVM)-capable product in the modern market given these and other issues. Improved assembly techniques, such as discussed herein, may address key failure points in traditional CPO assembly, including the fiber attach process, to helps deliver healthier process yields and contribute to realizing HVM-friendly CPO assembly processes, among other example benefits.

In some implementations, optical wires (or fibers) may be affixed to respective alignment grooves or trenches with an adhesive. For instance, a photo- or heat-curable adhesive (e.g., an epoxy) may be dispensed onto the alignment channel prior to or after placement of the optical wire into the alignment channel. In other embodiments, the optical wire or the groove may be pre-coated with a partially cured adhesive, which may be processed to fully cure the adhesive once the optical wires are seated in the alignment grooves. In some embodiments, the adhesive may be selected for its refractive index-matching properties. The refractive-index-matching adhesive may extend into a gap between the terminal facet of the optical fiber and the optical component aperture (e.g., of a PIC waveguide) to lower insertion loss of the interface, among other example benefits.

In some CPO applications, a refractive index of the optical fibers and the PIC waveguide may be between 1.4 and 1.5. Traditional adhesives, which have refractive indexes in this range are very limited and were thought to be limited silicone-based adhesives. Index matching adhesives may play a critical role in reducing insertion loss in CPO applications. However, silicone-based adhesives have suffered from high delamination risk. For instance, silicone is intrinsically hydrophobic qualities leading to low adhesion to other surfaces, which inhibits the permanency of the adhesive bond and leads to high incidences of detachment/delamination of components adhered using such adhesives. Further, silicone-based adhesives typically contain low molecular weight oligomers that have a tendency to migrate or leak out of their area of application to potentially contaminate other areas and inhibit high precision assembly, among other example failures.

An improved optical adhesive may be provided, which offers superior performance as an adhesive (e.g., when compared to silicone-based adhesives), while serving as a suitably refractive index-matched adhesive for CPO applications. For instance, an improved optical adhesive may use polyethylene oxide (PEO) as the base chemistry together with other functional segments and copolymers to tune the optical adhesive's refractive index, modulus, and glass transition temperature to suit a corresponding optical interface (e.g., in a CPO solution). Within the context of this disclosure, a refractive index may be considered “matched” even if there is some variance between a refractive index (e.g., of an adhesive) and a target refractive index (e.g., an optical wire and/or waveguide), which still allows the resulting insertion loss to fall within an allowed target range (e.g., as defined within a specification for an CPO assembly). For instance, in some cases, a refractive index may be considered matched when the value is within 10% of another (or target) material's refractive index value, among other examples.

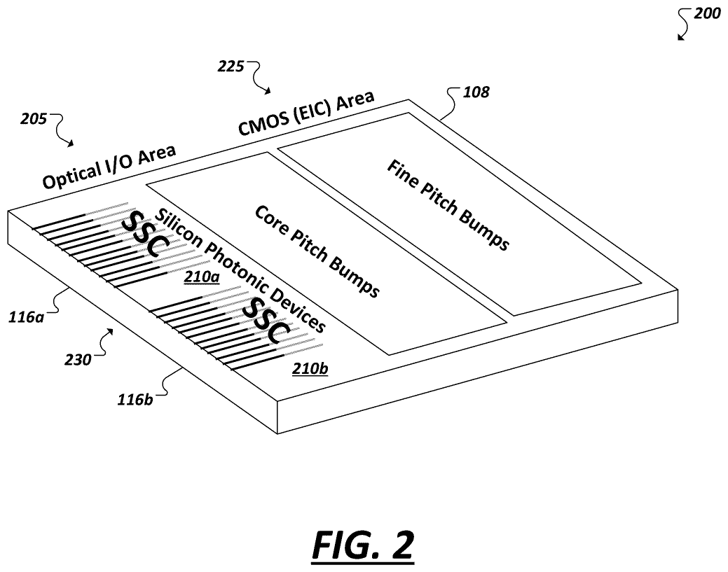

Turning to FIG. 2, a diagram 200 of an example PIC device 108 is shown. In this example, the PIC 108 may include an optical I/O area 205, including V-grooves 116a-b to accept an array of optical fibers and align the fibers with waveguides of the PIC (e.g., as implemented in spot size converter 210a-b hardware). Pitch bumps (e.g., 215, 220) may be provided on the die 108 to couple the PIC 108 to a package. In some implementations, the PIC 108 may include an EIC area 225 for circuitry to further process signals corresponding to the optical signals to be sent and received over the optical interface 230 of the PIC (e.g., SER-DES, signal conditioning, electrical link training, etc.). The improved, PEO-based optical adhesive may be deposited in the V-grooves 116a-b and/or the corresponding fibers to affix the individual optical fibers (and the collective optical ribbon) to the optical I/O interface 230.

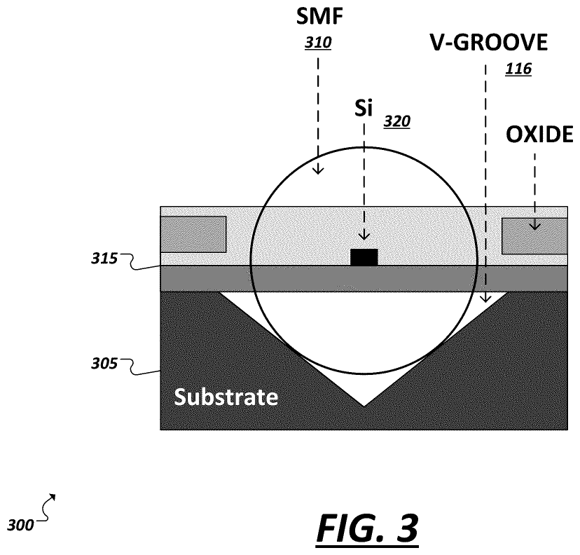

Turning to FIG. 3, a close-up cross-sectional view 300 of a portion of an optical I/O interface is illustrated. A V-groove 116 is formed in a substrate 305 (e.g., of the die or package). A fiber 310 is set within the V-groove 116, which aligns the fiber 310 with an SSC waveguide layer 315 and a silicon emitter/receiver element 320. The elements of the I/O interface (e.g., the fiber 305 and SSC membrane 315) may be particularly fragile and prone to breakage. Indeed, the optical adhesive should have a degree of elasticity so as not to threaten the structural integrity of the interface elements. For instance, the PEO-based optical adhesive may have modulus and glass transition temperature values that correspond to physical characteristics amenable for use in securing the fibers to the SSC, without threatening or encouraging breakage of these interface elements, among other example features. Indeed, a PEO-based optical adhesive may be highly tunable in terms of both modulus and refractive index, allowing such adhesives to be formulated to the specifications of various optical I/O interface applications. Further, a PEO-based optical adhesive may possess high thermal stability, allowing the integrity of a bond facilitated by the PEO adhesive to be maintained, even at higher system operation temperatures. Further, the PEO adhesive, due to its hydrophilic nature, may result in minimal to no delamination risk at optical I/O interfaces secured using the adhesive, among other example benefits.

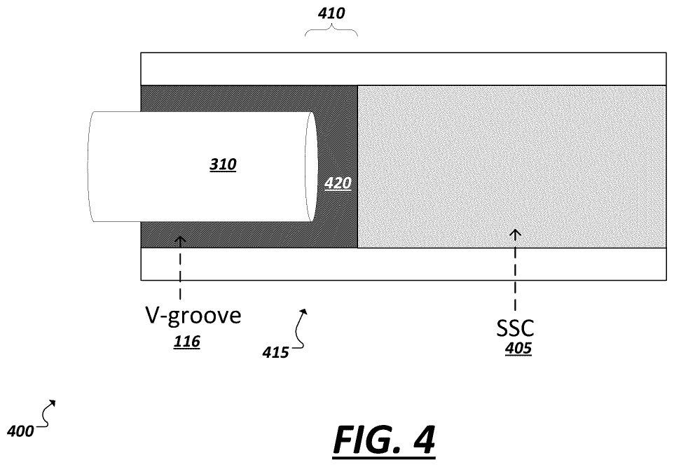

Turning to FIG. 4, a top view 400 of an example optical I/O interface is shown, including an optical fiber 310 (e.g., a single mode fiber (SMF), a multi-mode fiber (MMF), a polarization-maintaining (PM) fiber, etc.) set within a groove 116 and aligned with a waveguide 405 of an integrated circuit (e.g., a PIC). As illustrated in FIG. 4, it may be common (and even desirable in some cases) for air gaps (e.g., 410) to remain or exist between an end or terminus of a fiber 310 and a terminal facet of the waveguide 405 of an optical I/O interface 415. The PEO-based optical adhesive 420 may fill the air gap 410 among other gaps within the groove 116. The PEO-based optical adhesive may be suitably refractive index (RI)-matched to both the fiber 310 and waveguide 405 so as to minimize insertion loss due to variance between the RI characteristics of the fiber 310 and the waveguide 405 and the RI of the gap (e.g., 410) between them.

Optical I/O interface applications may have application-specific specifications based, for instance, on the materials used in the components of the interface. Table 1 below shows an example of a materials target specification (MTS) for adhesive to be used in an example optical I/O interface (e.g., for a PIC). For applications with an RI of 1.4, silicone-based adhesives may meet the RI-matching specifications for the application, but carry with it delamination and contamination risks. For applications with an RI of 1.5, epoxy-based adhesives may be used, however, thermoplastic characteristics of epoxy-based adhesives are difficult to modify and tune to the specifications of some optical applications. A PEO-based optical adhesive may be tuned to satisfy the example MTS of Table 1, while being flexible enough to be tuned for yet other existing and future MTS of other applications.

TABLE 1
Example Material Target Specification for RI-Matched Adhesives

| Properties | Target |
|---|---|
| Refractive index (RI) | 1.4 or 1.5 depending on designs |
| Thermal stability | Stable at 260 C. reflow temperature |
| Glass transition temp | <0 C. |
| Modulus | <100 MPa |
| Process | Viscosity meeting dispense requirements |

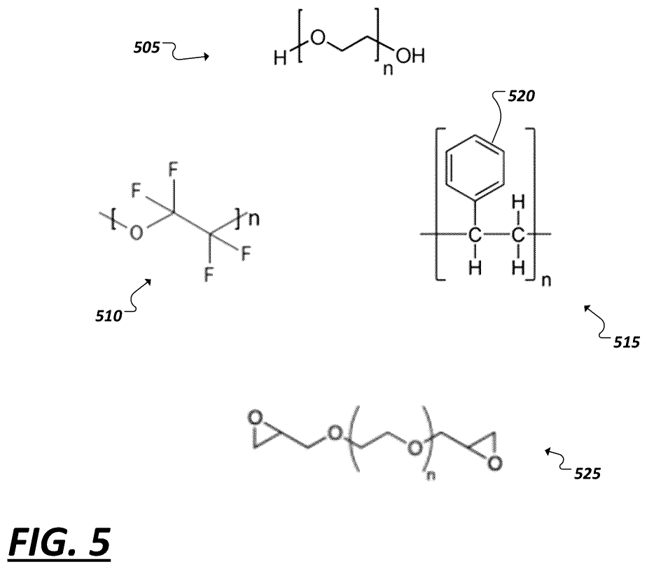

PEO, as well as its variants (e.g., polyethylene glycol (PEG) for low modular weight variants) includes properties that may leveraged as the basis of an optical adhesive, such as high thermal stability, low glass transition temperature, low modulus, and tunable viscosity. FIG. 5 shows the structure of a PEO monomer 505. The refractive index of PEO, however, may not fall within the optimized or desired RI range for index matching adhesives in some applications. In one application, the required RI range may be between 1.37-1.42, but the RI for PEO may be higher, such as a RI of 1.45. To address this, optical I/O interface components may be selected with RI matched to the RI of the PEO adhesive (e.g., with the resultant RI approximated using the volumetric average). Alternatively, the RI of a PEO-based adhesive may be tuned through the introduction of lower refractive index segments (e.g., fluoride-based monomers) to the PEO. For instance, a lower refractive index segment may be added in a PEO polymer chain to form a co-polymer. As another example, a lower refractive index polymer or solvent may be introduced to form an adhesive mixture. Indeed, a combination of approaches may be adopted to formulate the RI-tuned PEO adhesive (e.g., through a mixture including a PEO-lower refractive index segment co-polymer, etc.).

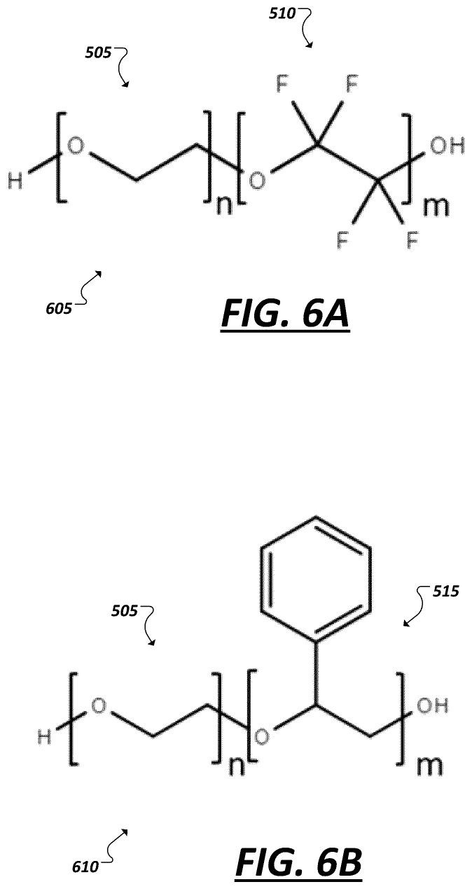

In one example, in order to formulate a PEO-based optical adhesive with a lower RI, fluoride (or F—) monomer may be introduced into the PEO polymer chain. As an example, poly(hexafluoropropylene oxide) (the molecular structure 510 of which is illustrated in FIG. 5) may have an RI as low as 1.30. A polymer chain to include PEO and poly(hexafluoropropylene oxide) monomers may be constructed to bring the RI of the resulting optical adhesive compound down below the typical RI of PEO to match the target RI of an intended optical interface application. FIG. 6A shows a representation of such a PEO and poly(hexafluoropropylene oxide) polymer chain 605. Adjusting the ratio of PEO to poly(hexafluoropropylene oxide) monomers may allow the RI of the resulting adhesive to be tuned with precision. Similarly, in applications where a higher RI is desired, monomers including conjugated structures may be used. As an example, monomers including a benzene ring molecule 520 may be utilized to tune the RI of a PEO-based optical adhesive upward. For instance, a polystyrene monomer 515, with an RI of 1.59, may be introduced to a PEO-based polymer chain to tune the RI value of a resulting adhesive compound to match a higher RI specification. FIG. 6B shows a representation of a PEO and polystyrene polymer chain 610.

In addition to tuning PEO-based optical adhesives to match RI specifications of an optical interface application (e.g., a CPO application), additional monomers may be incorporated to tune the thermomechanical properties (e.g., modulus and glass transition temperature) of the adhesive. While PEO is intrinsically a thermoplastic, in assembly materials and processes, a thermoset polymer may be preferred in order to maintain the structure integrity across a range of use conditions. A PEO-based compound may be converted to a thermoset material, for instance, by introducing cross-linking groups, such as epoxy or isocyanate. As an example, a polyethylene glycol diglicydyl ether (PEGDGE) monomer may be used as a crossing group within a PEO-based polymer chain (which may also include non-PEO monomers used for RI tuning (such as described above)) to adjust the thermoplasticity of the adhesive. For instance, modulus and glass transition temperature of the PEO-based optical adhesive may be adjusted according to the ratio of PEO to crossing groups in the compound (e.g., with a higher ratio of crossing groups resulting in less elasticity in the resulting adhesive).

As an illustrative example, a PEO-based adhesive compound may be produced using PEO blended with a low-RI solvent (e.g., water, acetone, isopropyl alcohol). For instance, a solvent miscible with PEO may be used with a RI of ˜1.33 to create a PEO-based optical adhesive with an RI of ˜1.41 (e.g., based on the volumetric average of each component). The PEO-based optical adhesive may be dispensed onto a fiber array-based optical package to secure the fiber array to the package. Traditional adhesives are generally unacceptable for use as optical adhesives due to the presence of fillers, which may result in light scattering and signal loss if not perfectly dispersed (and may result in worse insertion loss than if an air gap were maintained between the optical fibers and chip waveguides). Without the use of an RI-matched adhesive, the package insertion loss may be substantially worse (and potentially outside of interface specification tolerances) as compared with instances where an RI-matched optical adhesive is used. Table 2 shows results of an example comparison of the performance of instances of an example optical I/O interface when different adhesives are used to secure optical fibers to the interface. A PEO-based adhesive may maintain acceptable insertion loss tolerances, while eliminating delamination risks and cross-contamination issues common with state-of-the-art silicone-based adhesives, among other example benefits.

TABLE 2
Example Comparison of Optical Adhesive Performance

| | | Silicone-based | PEO-based |
|---|---|---|---|
| | No adhesive | adhesive | adhesive |
| RI | 1 (air) | 1.40 | 1.41 |
| Average IL (dB) | 9.2 | 4.7 | 6.3 |

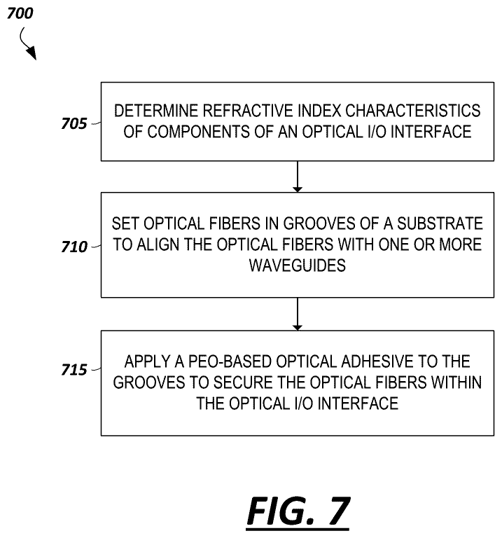

FIG. 7 is a simplified flow diagram 700 illustrating an example technique for securing optical fibers to an example optical I/O interface. For instance, the refractive index characteristics of the optical I/O interface components may be determined 705, including the refractive index of the optical fibers and the waveguide, interposer, or other interface element that is to pass light to or receive light from the terminal ends of the optical fibers at the optical I/O interface. The optical fibers may be set 710 within grooves formed (e.g., through etching) in a substrate of a die or package associated with the optical processing circuitry of the interface (e.g., the substrate of a PIC or CPO solution). The grooves are adapted to each accept one or more optical fibers and may serve to align ends of the optical fibers with apertures or waveguides of the optical processing circuitry. The grooves may be V-shaped or have potentially any other cross-sectional geometry. To secure the optical fibers within the grooves, a PEO-based optical adhesive may be applied 715 on or within the grooves. A PEO-based optical adhesive may have a refractive index based on and matched within a defined tolerance to one or both of the respective refractive index values of the optical I/O interface components (e.g., the optical fibers and a waveguide of the optical processing circuitry). In some cases, the PEO-based optical adhesive may be applied to the grooves before setting the optical fibers in the grooves. In other cases, the PEO-based optical adhesive may be applied (e.g., deposited) to the grooves after setting the optical fibers within the grooves. In some alternative implementations, the PEO-based optical adhesive may be pre-applied to either or both the grooves or the optical fibers and heated to “reactivate” the adhesive properties of the adhesive to allow the optical fibers to bond to the grooves using the PEO-based optical adhesive, among other example implementations. In some implementations, the application of the PEO-based optical adhesive may be limited or focused to filling an airgap between the optical fibers and the waveguides. Indeed, in some instances, a different (e.g., non-PEO or refractive-index-matched adhesive) may be used to secure the optical fibers in the grooves, with the PEO-based optical adhesive reserved for the airgap between the optical fibers and the waveguide(s), among other example implementations.

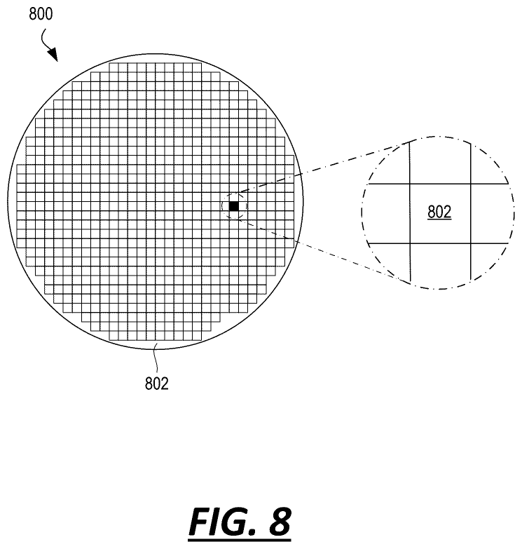

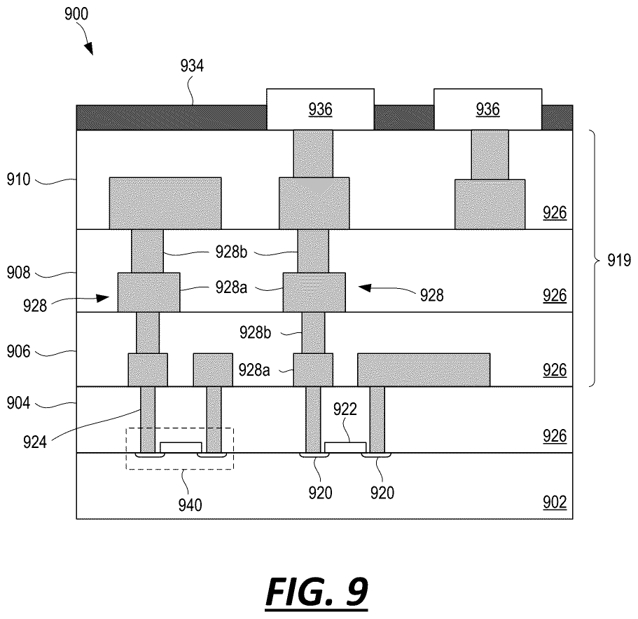

FIG. 8 is a top view of a wafer 800 and dies 802 that may be included in any of the integrated circuit packages 100 disclosed herein (e.g., as any suitable ones of the dies 106, 108, 80). The wafer 800 may be composed of semiconductor material and may include one or more dies 802 having integrated circuit structures formed on a surface of the wafer 800. The individual dies 802 may be a repeating unit of an integrated circuit product that includes any suitable integrated circuit. After the fabrication of the semiconductor product is complete, the wafer 800 may undergo a singulation process in which the dies 802 are separated from one another to provide discrete “chips” of the integrated circuit product. The die 802 may be any of the dies 106, 108, 110 disclosed herein. The die 802 may include one or more transistors (e.g., some of the transistors 940 of FIG. 9, discussed below), supporting circuitry to route electrical signals to the transistors, passive components (e.g., signal traces, resistors, capacitors, or inductors), and/or any other integrated circuit components. In some embodiments, the wafer 800 or the die 802 may include a memory device (e.g., a random access memory (RAM) device, such as a static RAM (SRAM) device, a magnetic RAM (MRAM) device, a resistive RAM (RRAM) device, a conductive-bridging RAM (CBRAM) device, etc.), a logic device (e.g., an AND, OR, NAND, or NOR gate), or any other suitable circuit element. Multiple ones of these devices may be combined on a single die 802. For example, a memory array formed by multiple memory devices may be formed on a same die 802 as a processor unit (e.g., the processor unit 802 of FIG. 8) or other logic that is configured to store information in the memory devices or execute instructions stored in the memory array. Various ones of the integrated circuit packages 100 disclosed herein may be manufactured using a die-to-wafer assembly technique in which some dies 106, 108, 110 are attached to a wafer 800 that include others of the dies 106, 108, 110, and the wafer 800 is subsequently singulated.

FIG. 9 is a cross-sectional side view of an integrated circuit device 900 that may be included in any of the integrated circuit packages 100 disclosed herein (e.g., in any of the dies 106, 108, 110). One or more of the integrated circuit devices 900 may be included in one or more dies 802 (FIG. 8). The integrated circuit device 900 may be formed on a die substrate 902 (e.g., the wafer 800 of FIG. 8) and may be included in a die (e.g., the die 802 of FIG. 8). The die substrate 902 may be a semiconductor substrate composed of semiconductor material systems including, for example, n-type or p-type materials systems (or a combination of both). The die substrate 902 may include, for example, a crystalline substrate formed using a bulk silicon or a silicon-on-insulator (SOI) substructure. In some embodiments, the die substrate 902 may be formed using alternative materials, which may or may not be combined with silicon, that include, but are not limited to, germanium, indium antimonide, lead telluride, indium arsenide, indium phosphide, gallium arsenide, or gallium antimonide. Further materials classified as group II-VI, III-V, or IV may also be used to form the die substrate 902. Although a few examples of materials from which the die substrate 902 may be formed are described here, any material that may serve as a foundation for an integrated circuit device 900 may be used. The die substrate 902 may be part of a singulated die (e.g., the dies 802 of FIG. 8) or a wafer (e.g., the wafer 800 of FIG. 8).

The integrated circuit device 900 may include one or more device layers 904 disposed on the die substrate 902. The device layer 904 may include features of one or more transistors 940 (e.g., metal oxide semiconductor field-effect transistors (MOSFETs)) formed on the die substrate 902. The transistors 940 may include, for example, one or more source and/or drain (S/D) regions 920, a gate 922 to control current flow between the S/D regions 920, and one or more S/D contacts 924 to route electrical signals to/from the S/D regions 920. The transistors 940 may include additional features not depicted for the sake of clarity, such as device isolation regions, gate contacts, and the like. The transistors 940 are not limited to the type and configuration depicted in FIG. 9 and may include a wide variety of other types and configurations such as, for example, planar transistors, non-planar transistors, or a combination of both. Non-planar transistors may include FinFET transistors, such as double-gate transistors or tri-gate transistors, and wrap-around or all-around gate transistors, such as nanoribbon, nanosheet, or nanowire transistors.

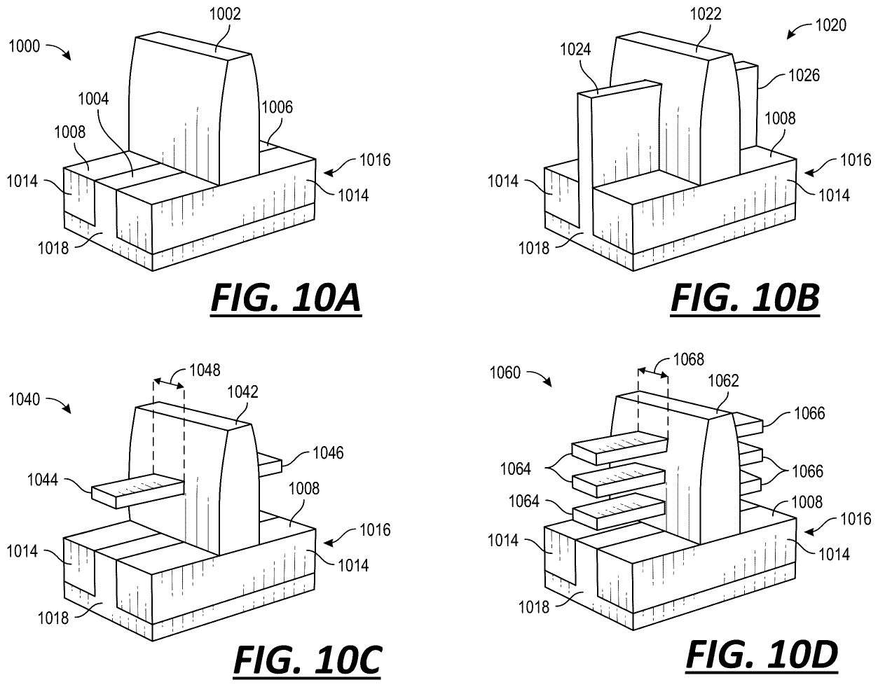

FIGS. 10A-10D are simplified perspective views of example planar, FinFET, gate-all-around, and stacked gate-all-around transistors. The transistors illustrated in FIGS. 10A-10D are formed on a substrate 1016 having a surface 1008. Isolation regions 1014 separate the source and drain regions of the transistors from other transistors and from a bulk region 1018 of the substrate 1016.

FIG. 10A is a perspective view of an example planar transistor 1000 comprising a gate 1002 that controls current flow between a source region 1004 and a drain region 1006. The transistor 1000 is planar in that the source region 1004 and the drain region 1006 are planar with respect to the substrate surface 1008.

FIG. 10B is a perspective view of an example FinFET transistor 1020 comprising a gate 1022 that controls current flow between a source region 1024 and a drain region 1026. The transistor 1020 is non-planar in that the source region 1024 and the drain region 1026 comprise “fins” that extend upwards from the substrate surface 1028. As the gate 1022 encompasses three sides of the semiconductor fin that extends from the source region 1024 to the drain region 1026, the transistor 1020 can be considered a tri-gate transistor. FIG. 10B illustrates one S/D fin extending through the gate 1022, but multiple S/D fins can extend through the gate of a FinFET transistor.

FIG. 10C is a perspective view of a gate-all-around (GAA) transistor 1040 comprising a gate 1042 that controls current flow between a source region 1044 and a drain region 1046. The transistor 1040 is non-planar in that the source region 1044 and the drain region 1046 are elevated from the substrate surface 1028.

FIG. 10D is a perspective view of a GAA transistor 1060 comprising a gate 1062 that controls current flow between multiple elevated source regions 1064 and multiple elevated drain regions 1066. The transistor 1060 is a stacked GAA transistor as the gate controls the flow of current between multiple elevated S/D regions stacked on top of each other. The transistors 1040 and 1060 are considered gate-all-around transistors as the gates encompass all sides of the semiconductor portions that extends from the source regions to the drain regions. The transistors 1040 and 1060 can alternatively be referred to as nanowire, nanosheet, or nanoribbon transistors depending on the width (e.g., widths 1048 and 1068 of transistors 1040 and 1060, respectively) of the semiconductor portions extending through the gate.

Returning to FIG. 9, a transistor 940 may include a gate 922 formed of at least two layers, a gate dielectric and a gate electrode. The gate dielectric may include one layer or a stack of layers. The one or more layers may include silicon oxide, silicon dioxide, silicon carbide, and/or a high-k dielectric material.

The high-k dielectric material may include elements such as hafnium, silicon, oxygen, titanium, tantalum, lanthanum, aluminum, zirconium, barium, strontium, yttrium, lead, scandium, niobium, and zinc. Examples of high-k materials that may be used in the gate dielectric include, but are not limited to, hafnium oxide, hafnium silicon oxide, lanthanum oxide, lanthanum aluminum oxide, zirconium oxide, zirconium silicon oxide, tantalum oxide, titanium oxide, barium strontium titanium oxide, barium titanium oxide, strontium titanium oxide, yttrium oxide, aluminum oxide, lead scandium tantalum oxide, and lead zinc niobate. In some embodiments, an annealing process may be carried out on the gate dielectric to improve its quality when a high-k material is used.

The gate electrode may be formed on the gate dielectric and may include at least one p-type work function metal or n-type work function metal, depending on whether the transistor 940 is to be a p-type metal oxide semiconductor (PMOS) or an n-type metal oxide semiconductor (NMOS) transistor. In some implementations, the gate electrode may consist of a stack of two or more metal layers, where one or more metal layers are work function metal layers and at least one metal layer is a fill metal layer. Further metal layers may be included for other purposes, such as a barrier layer.

For a PMOS transistor, metals that may be used for the gate electrode include, but are not limited to, ruthenium, palladium, platinum, cobalt, nickel, conductive metal oxides (e.g., ruthenium oxide), and any of the metals discussed below with reference to an NMOS transistor (e.g., for work function tuning). For an NMOS transistor, metals that may be used for the gate electrode include, but are not limited to, hafnium, zirconium, titanium, tantalum, aluminum, alloys of these metals, carbides of these metals (e.g., hafnium carbide, zirconium carbide, titanium carbide, tantalum carbide, and aluminum carbide), and any of the metals discussed above with reference to a PMOS transistor (e.g., for work function tuning).

In some embodiments, when viewed as a cross-section of the transistor 940 along the source-channel-drain direction, the gate electrode may consist of a U-shaped structure that includes a bottom portion substantially parallel to the surface of the die substrate 902 and two sidewall portions that are substantially perpendicular to the top surface of the die substrate 902. In other embodiments, at least one of the metal layers that form the gate electrode may simply be a planar layer that is substantially parallel to the top surface of the die substrate 902 and does not include sidewall portions substantially perpendicular to the top surface of the die substrate 902. In other embodiments, the gate electrode may consist of a combination of U-shaped structures and planar, non-U-shaped structures. For example, the gate electrode may consist of one or more U-shaped metal layers formed atop one or more planar, non-U-shaped layers.

In some embodiments, a pair of sidewall spacers may be formed on opposing sides of the gate stack to bracket the gate stack. The sidewall spacers may be formed from materials such as silicon nitride, silicon oxide, silicon carbide, silicon nitride doped with carbon, and silicon oxynitride. Processes for forming sidewall spacers are well known in the art and generally include deposition and etching process steps. In some embodiments, a plurality of spacer pairs may be used; for instance, two pairs, three pairs, or four pairs of sidewall spacers may be formed on opposing sides of the gate stack.

The S/D regions 920 may be formed within the die substrate 902 adjacent to the gate 922 of individual transistors 940. The S/D regions 920 may be formed using an implantation/diffusion process or an etching/deposition process, for example. In the former process, dopants such as boron, aluminum, antimony, phosphorous, or arsenic may be ion-implanted into the die substrate 902 to form the S/D regions 920. Etching may also be leveraged to form grooves in the substrate corresponding to the resulting dies. An annealing process that activates the dopants and causes them to diffuse farther into the die substrate 902 may follow the ion-implantation process. In the latter process, the die substrate 902 may first be etched to form recesses at the locations of the S/D regions 920. An epitaxial deposition process may then be carried out to fill the recesses with material that is used to fabricate the S/D regions 920. In some implementations, the S/D regions 920 may be fabricated using a silicon alloy such as silicon germanium or silicon carbide. In some embodiments, the epitaxially deposited silicon alloy may be doped in situ with dopants such as boron, arsenic, or phosphorous. In some embodiments, the S/D regions 920 may be formed using one or more alternate semiconductor materials such as germanium or a group III-V material or alloy. In further embodiments, one or more layers of metal and/or metal alloys may be used to form the S/D regions 920.

Electrical signals, such as power and/or input/output (I/O) signals, may be routed to and/or from the devices (e.g., transistors 940) of the device layer 904 through one or more interconnect layers disposed on the device layer 904 (illustrated in FIG. 9 as interconnect layers 906-910). For example, electrically conductive features of the device layer 904 (e.g., the gate 922 and the S/D contacts 924) may be electrically coupled with the interconnect structures 928 of the interconnect layers 906-910. The one or more interconnect layers 906-910 may form a metallization stack (also referred to as an “ILD stack”) 919 of the integrated circuit device 900.

The interconnect structures 928 may be arranged within the interconnect layers 906-910 to route electrical signals according to a wide variety of designs; in particular, the arrangement is not limited to the particular configuration of interconnect structures 928 depicted in FIG. 9. Although a particular number of interconnect layers 906-910 is depicted in FIG. 9, embodiments of the present disclosure include integrated circuit devices having more or fewer interconnect layers than depicted.

In some embodiments, the interconnect structures 928 may include lines 928a and/or vias 928b filled with an electrically conductive material such as a metal. The lines 928a may be arranged to route electrical signals in a direction of a plane that is substantially parallel with a surface of the die substrate 902 upon which the device layer 904 is formed. For example, the lines 928a may route electrical signals in a direction in and out of the page and/or in a direction across the page. The vias 928b may be arranged to route electrical signals in a direction of a plane that is substantially perpendicular to the surface of the die substrate 902 upon which the device layer 904 is formed. In some embodiments, the vias 928b may electrically couple lines 928a of different interconnect layers 906-910 together.

The interconnect layers 906-910 may include a dielectric material 926 disposed between the interconnect structures 928, as shown in FIG. 9. In some embodiments, dielectric material 926 disposed between the interconnect structures 928 in different ones of the interconnect layers 906-910 may have different compositions; in other embodiments, the composition of the dielectric material 926 between different interconnect layers 906-910 may be the same. The device layer 904 may include a dielectric material 926 disposed between the transistors 940 and a bottom layer of the metallization stack as well. The dielectric material 926 included in the device layer 904 may have a different composition than the dielectric material 926 included in the interconnect layers 906-910; in other embodiments, the composition of the dielectric material 926 in the device layer 904 may be the same as a dielectric material 926 included in any one of the interconnect layers 906-910.

A first interconnect layer 906 (referred to as Metal 1 or “M1”) may be formed directly on the device layer 904. In some embodiments, the first interconnect layer 906 may include lines 928a and/or vias 928b, as shown. The lines 928a of the first interconnect layer 906 may be coupled with contacts (e.g., the S/D contacts 924) of the device layer 904. The vias 928b of the first interconnect layer 906 may be coupled with the lines 928a of a second interconnect layer 908.

The second interconnect layer 908 (referred to as Metal 2 or “M2”) may be formed directly on the first interconnect layer 906. In some embodiments, the second interconnect layer 908 may include via 928b to couple the lines 928 of the second interconnect layer 908 with the lines 928a of a third interconnect layer 910. Although the lines 928a and the vias 928b are structurally delineated with a line within individual interconnect layers for the sake of clarity, the lines 928a and the vias 928b may be structurally and/or materially contiguous (e.g., simultaneously filled during a dual-damascene process) in some embodiments.

The third interconnect layer 910 (referred to as Metal 3 or “M3”) (and additional interconnect layers, as desired) may be formed in succession on the second interconnect layer 908 according to similar techniques and configurations described in connection with the second interconnect layer 908 or the first interconnect layer 906. In some embodiments, the interconnect layers that are “higher up” in the metallization stack 919 in the integrated circuit device 900 (i.e., farther away from the device layer 904) may be thicker that the interconnect layers that are lower in the metallization stack 919, with lines 928a and vias 928b in the higher interconnect layers being thicker than those in the lower interconnect layers.

The integrated circuit device 900 may include a solder resist material 934 (e.g., polyimide or similar material) and one or more conductive contacts 936 formed on the interconnect layers 906-910. In FIG. 9, the conductive contacts 936 are illustrated as taking the form of bond pads. The conductive contacts 936 may be electrically coupled with the interconnect structures 928 and configured to route the electrical signals of the transistor(s) 940 to external devices. For example, solder bonds may be formed on the one or more conductive contacts 936 to mechanically and/or electrically couple an integrated circuit die including the integrated circuit device 900 with another component (e.g., a printed circuit board). The integrated circuit device 900 may include additional or alternate structures to route the electrical signals from the interconnect layers 906-910; for example, the conductive contacts 936 may include other analogous features (e.g., posts) that route the electrical signals to external components.

In some embodiments in which the integrated circuit device 900 is a double-sided die, the integrated circuit device 900 may include another metallization stack (not shown) on the opposite side of the device layer(s) 904. This metallization stack may include multiple interconnect layers as discussed above with reference to the interconnect layers 906-910, to provide conductive pathways (e.g., including conductive lines and vias) between the device layer(s) 904 and additional conductive contacts (not shown) on the opposite side of the integrated circuit device 900 from the conductive contacts 936.

In other embodiments in which the integrated circuit device 900 is a double-sided die, the integrated circuit device 900 may include one or more through silicon vias (TSVs) through the die substrate 902; these TSVs may make contact with the device layer(s) 904, and may provide conductive pathways between the device layer(s) 904 and additional conductive contacts (not shown) on the opposite side of the integrated circuit device 900 from the conductive contacts 936. In some embodiments, TSVs extending through the substrate can be used for routing power and ground signals from conductive contacts on the opposite side of the integrated circuit device 900 from the conductive contacts 936 to the transistors 940 and any other components integrated into the die 900, and the metallization stack 919 can be used to route I/O signals from the conductive contacts 936 to transistors 940 and any other components integrated into the die 900.

Multiple integrated circuit devices 900 may be stacked with one or more TSVs in the individual stacked devices providing connection between one of the devices to any of the other devices in the stack. For example, one or more high-bandwidth memory (HBM) integrated circuit dies can be stacked on top of a base integrated circuit die and TSVs in the HBM dies can provide connection between the individual HBM and the base integrated circuit die. Conductive contacts can provide additional connections between adjacent integrated circuit dies in the stack. In some embodiments, the conductive contacts can be fine-pitch solder bumps (microbumps).

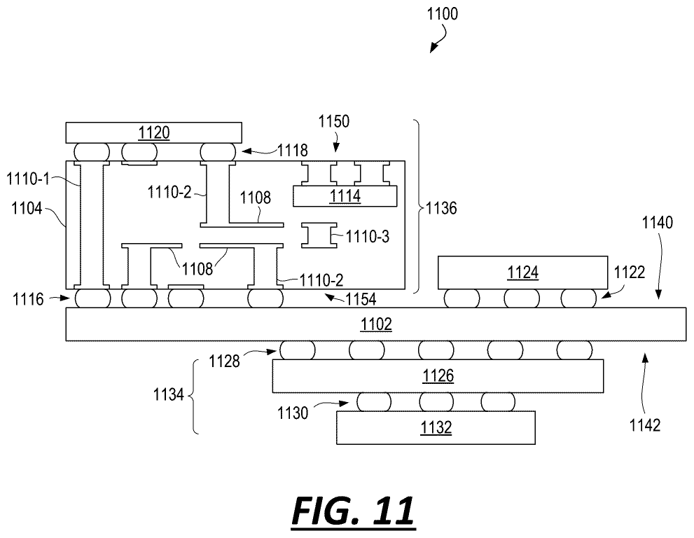

FIG. 11 is a cross-sectional side view of an integrated circuit device assembly 1100 that may include any of the integrated circuit packages 100 disclosed herein. In some embodiments, the integrated circuit device assembly 1100 may be an integrated circuit packages 100. The integrated circuit device assembly 1100 includes a number of components disposed on a circuit board 1102 (which may be a motherboard, system board, mainboard, etc.). The integrated circuit device assembly 1100 includes components disposed on a first face 1140 of the circuit board 1102 and an opposing second face 1142 of the circuit board 1102; generally, components may be disposed on one or both faces 1140 and 1142. Any of the integrated circuit components discussed below with reference to the integrated circuit device assembly 1100 may take the form of any suitable ones of the embodiments of the integrated circuit packages 100 disclosed herein.

In some embodiments, the circuit board 1102 may be a printed circuit board (PCB) including multiple metal (or interconnect) layers separated from one another by layers of dielectric material and interconnected by electrically conductive vias. The individual metal layers comprise conductive traces. Any one or more of the metal layers may be formed in a desired circuit pattern to route electrical signals (optionally in conjunction with other metal layers) between the components coupled to the circuit board 1102. In other embodiments, the circuit board 1102 may be a non-PCB substrate. In some embodiments the circuit board 1102 may be, for example, the substrate 102. The integrated circuit device assembly 1100 illustrated in FIG. 11 includes a package-on-interposer structure 1136 coupled to the first face 1140 of the circuit board 1102 by coupling components 1116. The coupling components 1116 may electrically and mechanically couple the package-on-interposer structure 1136 to the circuit board 1102, and may include solder balls (as shown in FIG. 11), pins (e.g., as part of a pin grid array (PGA), contacts (e.g., as part of a land grid array (LGA)), male and female portions of a socket, an adhesive, an underfill material, and/or any other suitable electrical and/or mechanical coupling structure.

The package-on-interposer structure 1136 may include an integrated circuit component 1120 coupled to an interposer 1104 by coupling components 1118. The coupling components 1118 may take any suitable form for the application, such as the forms discussed above with reference to the coupling components 1116. Although a single integrated circuit component 1120 is shown in FIG. 11, multiple integrated circuit components may be coupled to the interposer 1104; indeed, additional interposers may be coupled to the interposer 1104. The interposer 1104 may provide an intervening substrate used to bridge the circuit board 1102 and the integrated circuit component 1120.

The integrated circuit component 1120 may be a packaged or unpacked integrated circuit product that includes one or more integrated circuit dies (e.g., the die 802 of FIG. 8, the integrated circuit device 900 of FIG. 9) and/or one or more other suitable components. A packaged integrated circuit component comprises one or more integrated circuit dies mounted on a package substrate with the integrated circuit dies and package substrate encapsulated in a casing material, such as a metal, plastic, glass, or ceramic. In one example of an unpackaged integrated circuit component 1120, a single monolithic integrated circuit die comprises solder bumps attached to contacts on the die. The solder bumps allow the die to be directly attached to the interposer 1104. The integrated circuit component 1120 can comprise one or more computing system components, such as one or more processor units (e.g., system-on-a-chip (SoC), processor core, graphics processor unit (GPU), accelerator, chipset processor), I/O controller, memory, or network interface controller. In some embodiments, the integrated circuit component 1120 can comprise one or more additional active or passive devices such as capacitors, decoupling capacitors, resistors, inductors, fuses, diodes, transformers, sensors, electrostatic discharge (ESD) devices, and memory devices.

In embodiments where the integrated circuit component 1120 comprises multiple integrated circuit dies, they dies can be of the same type (a homogeneous multi-die integrated circuit component) or of two or more different types (a heterogeneous multi-die integrated circuit component). A multi-die integrated circuit component can be referred to as a multi-chip package (MCP) or multi-chip module (MCM).

In addition to comprising one or more processor units, the integrated circuit component 1120 can comprise additional components, such as embedded DRAM, stacked high bandwidth memory (HBM), shared cache memories, input/output (I/O) controllers, or memory controllers. Any of these additional components can be located on the same integrated circuit die as a processor unit, or on one or more integrated circuit dies separate from the integrated circuit dies comprising the processor units. These separate integrated circuit dies can be referred to as “chiplets”. In embodiments where an integrated circuit component comprises multiple integrated circuit dies, interconnections between dies can be provided by the package substrate, one or more silicon interposers, one or more silicon bridges embedded in the package substrate (such as Intel® embedded multi-die interconnect bridges (EMIBs)), or combinations thereof.

Generally, the interposer 1104 may spread connections to a wider pitch or reroute a connection to a different connection. For example, the interposer 1104 may couple the integrated circuit component 1120 to a set of ball grid array (BGA) conductive contacts of the coupling components 1116 for coupling to the circuit board 1102. In the embodiment illustrated in FIG. 11, the integrated circuit component 1120 and the circuit board 1102 are attached to opposing sides of the interposer 1104; in other embodiments, the integrated circuit component 1120 and the circuit board 1102 may be attached to a same side of the interposer 1104. In some embodiments, three or more components may be interconnected by way of the interposer 1104.

In some embodiments, the interposer 1104 may be formed as a PCB, including multiple metal layers separated from one another by layers of dielectric material and interconnected by electrically conductive vias. In some embodiments, the interposer 1104 may be formed of an epoxy resin, a fiberglass-reinforced epoxy resin, an epoxy resin with inorganic fillers, a ceramic material, or a polymer material such as polyimide. In some embodiments, the interposer 1104 may be formed of alternate rigid or flexible materials that may include the same materials described above for use in a semiconductor substrate, such as silicon, germanium, and other group III-V and group IV materials. The interposer 1104 may include metal interconnects 1108 and vias 1110, including but not limited to through hole vias 1110-1 (that extend from a first face 1150 of the interposer 1104 to a second face 1154 of the interposer 1104), blind vias 1110-2 (that extend from the first or second faces 1150 or 1154 of the interposer 1104 to an internal metal layer), and buried vias 1110-3 (that connect internal metal layers).

In some embodiments, the interposer 1104 can comprise a silicon interposer. Through silicon vias (TSV) extending through the silicon interposer can connect connections on a first face of a silicon interposer to an opposing second face of the silicon interposer. In some embodiments, an interposer 1104 comprising a silicon interposer can further comprise one or more routing layers to route connections on a first face of the interposer 1104 to an opposing second face of the interposer 1104.

The interposer 1104 may further include embedded devices 1114, including both passive and active devices. Such devices may include, but are not limited to, capacitors, decoupling capacitors, resistors, inductors, fuses, diodes, transformers, sensors, electrostatic discharge (ESD) devices, and memory devices. More complex devices such as radio frequency devices, power amplifiers, power management devices, antennas, arrays, sensors, and microelectromechanical systems (MEMS) devices may also be formed on the interposer 1104. The package-on-interposer structure 1136 may take the form of any of the package-on-interposer structures known in the art.

The integrated circuit device assembly 1100 may include an integrated circuit component 1124 coupled to the first face 1140 of the circuit board 1102 by coupling components 1122. The coupling components 1122 may take the form of any of the embodiments discussed above with reference to the coupling components 1116, and the integrated circuit component 1124 may take the form of any of the embodiments discussed above with reference to the integrated circuit component 1120.

The integrated circuit device assembly 1100 illustrated in FIG. 11 includes a package-on-package structure 1134 coupled to the second face 1142 of the circuit board 1102 by coupling components 1128. The package-on-package structure 1134 may include an integrated circuit component 1126 and an integrated circuit component 1132 coupled together by coupling components 1130 such that the integrated circuit component 1126 is disposed between the circuit board 1102 and the integrated circuit component 1132. The coupling components 1128 and 1130 may take the form of any of the embodiments of the coupling components 1116 discussed above, and the integrated circuit components 1126 and 1132 may take the form of any of the embodiments of the integrated circuit component 1120 discussed above. The package-on-package structure 1134 may be configured in accordance with any of the package-on-package structures known in the art.

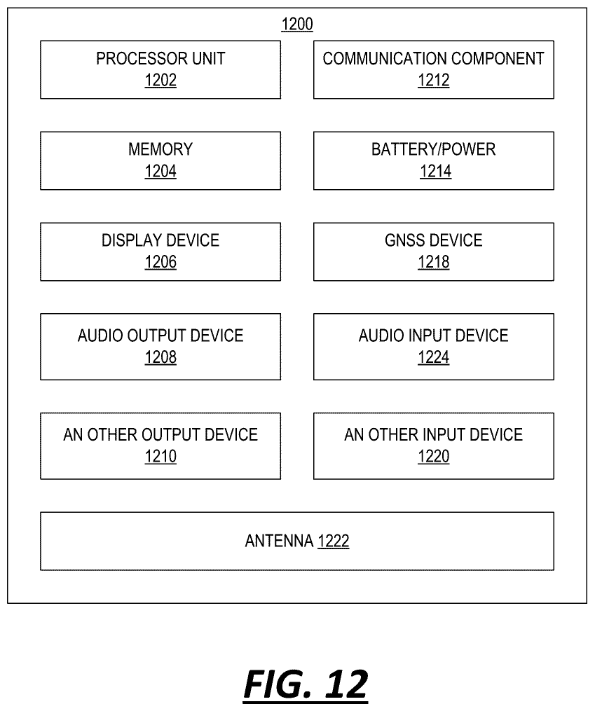

FIG. 12 is a block diagram of an example electrical device 1200 that may include one or more of the integrated circuit packages 100 disclosed herein. Components Of the electrical device (e.g., 1202, 1204, 1206, etc.) may be interconnected using optical interconnects, which may employ optical cabling attached to dies or packages using the PEO-based optical adhesive solutions discussed above. For example, any suitable ones of the components of the electrical device 1200 may include one or more of the integrated circuit device assemblies 1100, integrated circuit components 1120, integrated circuit devices 900, or integrated circuit dies 1202 disclosed herein, and may be arranged in any of the integrated circuit packages 100 disclosed herein. A number of components are illustrated in FIG. 12 as included in the electrical device 1200, but any one or more of these components may be omitted or duplicated, as suitable for the application. In some embodiments, some or all of the components included in the electrical device 1200 may be attached to one or more motherboards mainboards, or system boards. In some embodiments, one or more of these components are fabricated onto a single system-on-a-chip (SoC) die.

Additionally, in various embodiments, the electrical device 1200 may not include one or more of the components illustrated in FIG. 12, but the electrical device 1200 may include interface circuitry for coupling to the one or more components. For example, the electrical device 1200 may not include a display device 1206, but may include display device interface circuitry (e.g., a connector and driver circuitry) to which a display device 1206 may be coupled. In another set of examples, the electrical device 1200 may not include an audio input device 1224 or an audio output device 1208, but may include audio input or output device interface circuitry (e.g., connectors and supporting circuitry) to which an audio input device 1224 or audio output device 1208 may be coupled.

The electrical device 1200 may include one or more processor units 1202 (e.g., one or more processor units). As used herein, the terms “processor unit”, “processing unit” or “processor” may refer to any device or portion of a device that processes electronic data from registers and/or memory to transform that electronic data into other electronic data that may be stored in registers and/or memory. The processor unit 1202 may include one or more digital signal processors (DSPs), application-specific integrated circuits (ASICs), central processing units (CPUs), graphics processing units (GPUs), general-purpose GPUs (GPGPUs), accelerated processing units (APUs), field-programmable gate arrays (FPGAs), neural network processing units (NPUs), data processor units (DPUs), accelerators (e.g., graphics accelerator, compression accelerator, artificial intelligence accelerator), controller cryptoprocessors (specialized processors that execute cryptographic algorithms within hardware), server processors, controllers, or any other suitable type of processor units. As such, the processor unit can be referred to as an XPU (or xPU).

The electrical device 1200 may include a memory 1204, which may itself include one or more memory devices such as volatile memory (e.g., dynamic random access memory (DRAM), static random-access memory (SRAM)), non-volatile memory (e.g., read-only memory (ROM), flash memory, chalcogenide-based phase-change non-voltage memories), solid state memory, and/or a hard drive. In some embodiments, the memory 1204 may include memory that is located on the same integrated circuit die as the processor unit 1202. This memory may be used as cache memory (e.g., Level 1 (L1), Level 2 (L2), Level 3 (L3), Level 4 (L4), Last Level Cache (LLC)) and may include embedded dynamic random access memory (eDRAM) or spin transfer torque magnetic random access memory (STT-MRAM).

In some embodiments, the electrical device 1200 can comprise one or more processor units 1202 that are heterogeneous or asymmetric to another processor unit 1202 in the electrical device 1200. There can be a variety of differences between the processing units 1202 in a system in terms of a spectrum of metrics of merit including architectural, microarchitectural, thermal, power consumption characteristics, and the like. These differences can effectively manifest themselves as asymmetry and heterogeneity among the processor units 1202 in the electrical device 1200.

In some embodiments, the electrical device 1200 may include a communication component 1212 (e.g., one or more communication components). For example, the communication component 1212 can manage wireless communications for the transfer of data to and from the electrical device 1200. The term “wireless” and its derivatives may be used to describe circuits, devices, systems, methods, techniques, communications channels, etc., that may communicate data through the use of modulated electromagnetic radiation through a nonsolid medium. The term “wireless” does not imply that the associated devices do not contain any wires, although in some embodiments they might not.

The communication component 1212 may implement any of a number of wireless standards or protocols, including but not limited to Institute for Electrical and Electronic Engineers (IEEE) standards including Wi-Fi (IEEE 802.11 family), IEEE 802.16 standards (e.g., IEEE 802.16-2005 Amendment), Long-Term Evolution (LTE) project along with any amendments, updates, and/or revisions (e.g., advanced LTE project, ultra mobile broadband (UMB) project (also referred to as “3GPP2”), etc.). IEEE 802.16 compatible Broadband Wireless Access (BWA) networks are generally referred to as WiMAX networks, an acronym that stands for Worldwide Interoperability for Microwave Access, which is a certification mark for products that pass conformity and interoperability tests for the IEEE 802.16 standards. The communication component 1212 may operate in accordance with a Global System for Mobile Communication (GSM), General Packet Radio Service (GPRS), Universal Mobile Telecommunications System (UMTS), High Speed Packet Access (HSPA), Evolved HSPA (E-HSPA), or LTE network. The communication component 1212 may operate in accordance with Enhanced Data for GSM Evolution (EDGE), GSM EDGE Radio Access Network (GERAN), Universal Terrestrial Radio Access Network (UTRAN), or Evolved UTRAN (E-UTRAN). The communication component 1212 may operate in accordance with Code Division Multiple Access (CDMA), Time Division Multiple Access (TDMA), Digital Enhanced Cordless Telecommunications (DECT), Evolution-Data Optimized (EV-DO), and derivatives thereof, as well as any other wireless protocols that are designated as 3G, 4G, 5G, and beyond. The communication component 1212 may operate in accordance with other wireless protocols in other embodiments. The electrical device 1200 may include an antenna 1222 to facilitate wireless communications and/or to receive other wireless communications (such as AM or FM radio transmissions).

In some embodiments, the communication component 1212 may manage wired communications, such as electrical, optical, or any other suitable communication protocols (e.g., IEEE 802.3 Ethernet standards). As noted above, the communication component 1212 may include multiple communication components. For instance, a first communication component 1212 may be dedicated to shorter-range wireless communications such as Wi-Fi or Bluetooth, and a second communication component 1212 may be dedicated to longer-range wireless communications such as global positioning system (GPS), EDGE, GPRS, CDMA, WiMAX, LTE, EV-DO, or others. In some embodiments, a first communication component 1212 may be dedicated to wireless communications, and a second communication component 1212 may be dedicated to wired communications.

The electrical device 1200 may include battery/power circuitry 1214. The battery/power circuitry 1214 may include one or more energy storage devices (e.g., batteries or capacitors) and/or circuitry for coupling components of the electrical device 1200 to an energy source separate from the electrical device 1200 (e.g., AC line power).

The electrical device 1200 may include a display device 1206 (or corresponding interface circuitry, as discussed above). The display device 1206 may include one or more embedded or wired or wirelessly connected external visual indicators, such as a heads-up display, a computer monitor, a projector, a touchscreen display, a liquid crystal display (LCD), a light-emitting diode display, or a flat panel display.

The electrical device 1200 may include an audio output device 1208 (or corresponding interface circuitry, as discussed above). The audio output device 1208 may include any embedded or wired or wirelessly connected external device that generates an audible indicator, such as speakers, headsets, or earbuds.

The electrical device 1200 may include an audio input device 1224 (or corresponding interface circuitry, as discussed above). The audio input device 1224 may include any embedded or wired or wirelessly connected device that generates a signal representative of a sound, such as microphones, microphone arrays, or digital instruments (e.g., instruments having a musical instrument digital interface (MIDI) output). The electrical device 1200 may include a Global Navigation Satellite System (GNSS) device 1218 (or corresponding interface circuitry, as discussed above), such as a Global Positioning System (GPS) device. The GNSS device 1218 may be in communication with a satellite-based system and may determine a geolocation of the electrical device 1200 based on information received from one or more GNSS satellites, as known in the art.

The electrical device 1200 may include another output device 1210 (or corresponding interface circuitry, as discussed above). Examples of the other output device 1210 may include an audio codec, a video codec, a printer, a wired or wireless transmitter for providing information to other devices, or an additional storage device.

The electrical device 1200 may include another input device 1220 (or corresponding interface circuitry, as discussed above). Examples of the other input device 1220 may include an accelerometer, a gyroscope, a compass, an image capture device (e.g., monoscopic or stereoscopic camera), a trackball, a trackpad, a touchpad, a keyboard, a cursor control device such as a mouse, a stylus, a touchscreen, proximity sensor, microphone, a bar code reader, a Quick Response (QR) code reader, electrocardiogram (ECG) sensor, PPG (photoplethysmogram) sensor, galvanic skin response sensor, any other sensor, or a radio frequency identification (RFID) reader.

The electrical device 1200 may have any desired form factor, such as a hand-held or mobile electrical device (e.g., a cell phone, a smart phone, a mobile internet device, a music player, a tablet computer, a laptop computer, a 2-in-1 convertible computer, a portable all-in-one computer, a netbook computer, an ultrabook computer, a personal digital assistant (PDA), an ultra mobile personal computer, a portable gaming console, etc.), a desktop electrical device, a server, a rack-level computing solution (e.g., blade, tray or sled computing systems), a workstation or other networked computing component, a printer, a scanner, a monitor, a set-top box, an entertainment control unit, a stationary gaming console, smart television, a vehicle control unit, a digital camera, a digital video recorder, a wearable electrical device or an embedded computing system (e.g., computing systems that are part of a vehicle, smart home appliance, consumer electronics product or equipment, manufacturing equipment). In some embodiments, the electrical device 1200 may be any other electronic device that processes data. In some embodiments, the electrical device 1200 may comprise multiple discrete physical components. Given the range of devices that the electrical device 1200 can be manifested as in various embodiments, in some embodiments, the electrical device 1200 can be referred to as a computing device or a computing system.

The following examples pertain to embodiments in accordance with this Specification. Example 1 is an apparatus including: photonic processing circuitry; a waveguide to send or receive photonic signals for the photonics processing circuitry; a substrate including grooves configured to accept optical fibers; and optical fibers set within the grooves and adhered to the substrate by a polyethylene oxide (PEO)-based adhesive.

Example 2 includes the subject matter of example 1, where the grooves align ends of the optical fibers with the waveguide.

Example 3 includes the subject matter of any one of examples 1-2, where the grooves include V-grooves.

Example 4 includes the subject matter of any one of examples 1-3, where a material of the waveguide and a material of the optical fibers have a matched refractive index.

Example 5 includes the subject matter of example 4, where a refractive index of the PEO-based adhesive is matched to the matched refractive index.

Example 6 includes the subject matter of example 5, where an air gap between ends of the optical fibers and a terminal facet of the waveguide is filled with the PEO-based adhesive.

Example 7 includes the subject matter of any one of examples 5-6, where the PEO-based adhesive includes a polymer chain including PEO monomers and fluoride monomers, where the refractive index of the PEO-based adhesive is matched based on a ratio of fluoride monomers to PEO monomers.

Example 8 includes the subject matter of any one of examples 5-6, where the PEO-based adhesive includes a polymer chain including PEO monomers and benzene-inclusive monomers, where the refractive index of the PEO-based adhesive is matched based on a ratio of benzene-inclusive monomers to PEO monomers.

Example 9 includes the subject matter of any one of examples 1-8, where the photonic processing circuitry includes a photonic integrated circuit (PIC) and the PIC includes the waveguide.

Example 10 includes the subject matter of example 9, further including a computing package, where the substrate includes a substrate of the computing package and the PIC is mounted on the computing package.

Example 11 includes the subject matter of example 9, where the PIC includes the substrate.

Example 12 includes the subject matter of any one of examples 1-11, where the PEO-based adhesive includes a thermoset plastic.

Example 13 includes the subject matter of example 12, where the PEO-based adhesive includes a plurality of cross-linked PEO polymer chains.

Example 14 includes the subject matter of any one of examples 1-13, further including an optical ribbon including the optical fibers, where the optical ribbon includes a plurality of optical fibers and the grooves include a plurality of grooves.

Example 15 includes the subject matter of any one of examples 1-14, where the waveguide includes a spot size converter (SSC).

Example 16 is a method including: setting one or more optical fibers in grooves of a substrate to align the one or more optical fibers with one or more waveguides in an optical I/O interface; and dispensing an optical adhesive in the grooves of the substrate to adhere the optical fibers within the grooves and fill an air gap between ends of the one or more optical fibers and the one or more waveguides, where the optical adhesive includes polyethylene oxide (PEO) and a refractive index of the optical adhesive matches a refractive index of at least one of the one or more waveguides or the one or more optical fibers.

Example 17 includes the subject matter of example 16, where the refractive index of the optical adhesive matches the refractive index of the one or more waveguides and the one or more optical fibers.

Example 18 includes the subject matter of any one of examples 16-17, where the optical adhesive includes one of a fluoride-based monomer or a benzene-based monomer to assist in matching the refractive index of the optical adhesive to the refractive index of the one or more waveguides or the one or more optical fibers.

Example 19 includes the subject matter of example 16, where the one or more waveguides include waveguides of a photonics integrated chip (PIC).

Example 20 includes the subject matter of example 19, where the PIC includes the substrate.

Example 21 includes the subject matter of example 19, where the substrate includes a substrate of a package and the PIC is mounted on the package.

Example 22 includes the subject matter of any one of examples 16-21, where the one or more optical fibers include a plurality of optical fibers in an optical ribbon and the grooves include a plurality of grooves.

Example 23 includes the subject matter of any one of examples 16-22, where the grooves include V-grooves.

Example 24 includes the subject matter of any one of examples 16-23, where the optical adhesive includes a polymer chain including PEO monomers and fluoride monomers, where the refractive index of the PEO-based adhesive is matched based on a ratio of fluoride monomers to PEO monomers.

Example 25 includes the subject matter of any one of examples 16-24, where the optical adhesive includes a polymer chain including PEO monomers and benzene-inclusive monomers, where the refractive index of the PEO-based adhesive is matched based on a ratio of benzene-inclusive monomers to PEO monomers.

Example 26 includes the subject matter of any one of examples 16-25, where the optical adhesive includes a thermoset plastic.

Example 27 includes the subject matter of example 26, where the optical adhesive includes a plurality of cross-linked PEO polymer chains.

Example 28 is an adhesive compound including: a polymer chain including a polyethylene oxide (PEO) monomer, where the polymer chain has a refractive index of less 1.5; and a solvent, where the adhesive compound is configured to secure components of an optical I/O interface.

Example 29 includes the subject matter of example 28, where the polymer chain further includes fluoride monomers.

Example 30 includes the subject matter of any one of examples 28-29, where the adhesive compound includes a thermoset plastic.

Example 31 includes the subject matter of example 30, further including a number of cross-links between the polymer chain and another instance of the polymer chain.

Example 32 includes the subject matter of any one of examples 28-31, where a refractive index of the solvent is less than the refractive index of the polymer chain.

Example 33 is an adhesive compound including: a polymer chain including a polyethylene oxide (PEO) monomer, where the polymer chain has a refractive index of greater than 1.4; and a solvent, where the adhesive compound is configured to secure components of an optical I/O interface.

Example 34 includes the subject matter of example 33, where the polymer chain further includes benzene monomers.

Example 35 includes the subject matter of any one of examples 33-34, where the adhesive compound includes a thermoset plastic.

Example 36 includes the subject matter of example 35, further including a number of cross-links between the polymer chain and another instance of the polymer chain.

Example 37 includes the subject matter of any one of examples 33-36, where a refractive index of the solvent is less than the refractive index of the polymer chain.

Example 38 is a system including: a first device; and a second device coupled to the first device by an optical interconnect, where the optical interconnect includes one or more optical fibers, and the second device includes: photonic processing circuitry; a waveguide to send or receive photonic signals for the photonics processing circuitry; and a substrate including grooves configured to accept optical fibers, where the one or more optical fibers of the optical interconnect are adhered within the grooves by a polyethylene oxide (PEO)-based adhesive.

Example 39 includes the subject matter of example 38, where the second device includes the apparatus of any one of examples 1-15.

In the foregoing specification, a detailed description has been given with reference to specific exemplary embodiments. It will, however, be evident that various modifications and changes may be made thereto without departing from the broader spirit and scope of the disclosure as set forth in the appended claims. The specification and drawings are, accordingly, to be regarded in an illustrative sense rather than a restrictive sense. Furthermore, the foregoing use of embodiment and other exemplarily language does not necessarily refer to the same embodiment or the same example, but may refer to different and distinct embodiments, as well as potentially the same embodiment.

1. An apparatus comprising:
photonic processing circuitry;
a waveguide to send or receive photonic signals for the photonics processing circuitry;
a substrate comprising grooves to accept optical fibers; and
optical fibers set within the grooves and adhered to the substrate by a polyethylene oxide (PEO)-based adhesive.

2. The apparatus of claim 1, wherein the grooves align ends of the optical fibers with the waveguide.

3. The apparatus of claim 1, wherein the grooves comprise V-grooves.

4. The apparatus of claim 1, wherein a material of the waveguide and a material of the optical fibers have a matched refractive index.

5. The apparatus of claim 4, wherein a refractive index of the PEO-based adhesive is matched to the matched refractive index.

6. The apparatus of claim 5, wherein an air gap between ends of the optical fibers and a terminal facet of the waveguide is filled with the PEO-based adhesive.

7. The apparatus of claim 5, wherein the PEO-based adhesive comprises a polymer chain comprising PEO monomers and fluoride monomers, wherein the refractive index of the PEO-based adhesive is matched based on a ratio of fluoride monomers to PEO monomers.

8. The apparatus of claim 5, wherein the PEO-based adhesive comprises a polymer chain comprising PEO monomers and benzene-inclusive monomers, wherein the refractive index of the PEO-based adhesive is matched based on a ratio of benzene-inclusive monomers to PEO monomers.

9. The apparatus of claim 1, wherein the photonic processing circuitry comprises a photonic integrated circuit (PIC) and the PIC comprises the waveguide and substrate.

10. The apparatus of claim 1, wherein the PEO-based adhesive comprises a thermoset plastic.

11. The apparatus of claim 10, wherein the PEO-based adhesive comprises a plurality of cross-linked PEO polymer chains.

12. The apparatus of claim 1, further comprising an optical ribbon comprising the optical fibers, wherein the optical ribbon comprises a plurality of optical fibers and grooves comprises a plurality of grooves.

13. A method comprising:
setting one or more optical fibers in grooves of a substrate to align the one or more optical fibers with one or more waveguides in an optical I/O interface; and
dispensing an optical adhesive in the grooves of the substrate to adhere the optical fibers within the grooves and fill an air gap between ends of the one or more optical fibers and the one or more waveguides, wherein the optical adhesive comprises polyethylene oxide (PEO) and a refractive index of the optical adhesive matches a refractive index of at least one of the one or more waveguides or the one or more optical fibers.

14. The method of claim 13, wherein the refractive index of the optical adhesive matches the refractive index of the one or more waveguides and the one or more optical fibers.

15. The method of claim 13, wherein the optical adhesive comprises one of a fluoride-based monomer or a benzene-based monomer to assist in matching the refractive index of the optical adhesive to the refractive index of the one or more waveguides or the one or more optical fibers.

16. An adhesive compound to secure components of an optical I/O interface, the adhesive compound comprising:
a polymer chain comprising a polyethylene oxide (PEO) monomer, wherein the polymer chain has a refractive index of less 1.5.

17. The adhesive compound of claim 16, wherein the adhesive compound comprises a polymer blend comprising the PEO monomer and a fluoride monomer.

18. The adhesive compound of claim 16, wherein the adhesive compound comprises a thermoset plastic.

19. The adhesive compound of claim 18, further comprising a number of cross-links between the polymer chain and another instance of the polymer chain.

20. The adhesive compound of claim 16, wherein the adhesive compound comprises a polymer blend comprising the PEO monomer and a benzene-based monomer.
